(19) United States
(12) Patent Application Publication
(10) Pub. No.: US 2010/0018588 A1
(43) Pub. Date: Jan. 28, 2010

(54) SHOWER SYSTEM HAVING A PURIFYING AND DRYING FUNCTION

(76) Inventors: Woon Woo Lee, Kyungki-do (KR); EunKyung Yu, Seoul (KR)

Correspondence Address: IPLA P.A., 3580 WILSHIRE BLVD., 17TH FLOOR, LOS ANGELES, CA, 90010, US

(21) Appl. No.: 12/526,572

(22) PCT Filed: Mar. 10, 2008
(86) PCT No.: PCT/KR2008/001342

§ 371 Date: Aug. 10, 2009

(30) Foreign Application Priority Data
Mar. 9, 2007 (KR) 10-2007-0023303
Feb. 27, 2008 (KR) 10-2008-0017736

(51) Int. Cl. A47K 3/28

(52) U.S. Cl. 137/338; 4/612; 137/544; 137/560

(57) ABSTRACT

The present invention relates to a shower system having a drying device and a water purifying device, which does not allow a towel to be used for removing moistures on a body after taking a bath or shower using the shower in a bathroom, and exhausts warm winds occurring from the drying device through the shower head, so that the moistures on the body or head may be dried for a short time, and impurities contained in the tap water may be removed by the purifying device to make the water smooth, clear, and good for skin care.

### TECHNICAL FIELD

The present invention relates to a shower system, and more particularly, to a shower system composed of a blow dryer and a water purifier, which purities impurities contained in the water supplied from a water faucet at the time of taking a bath or shower in a bathroom and exhausts warm winds occurring on a dryer box from a shower head after taking a shower or bath to dry moistures on the head or body for a short time.

In addition, the present invention allows impurities contained in the tap water to be removed by a plurality of purifying filters to make the water clear, smooth, and good for skin care for taking a shower.

### BACKGROUND ART

In recent years, apartment houses are massively increasing with the development of the industrial society, so that environmental contamination also becomes severe social problems due to effects of the rapidly developing industrial society as well as effects of the living type, so that the health consciousness also becomes the new talk of the conversation due to such changes in society and environment.

Accordingly, People try to maintain their bodies in clean and healthy states due to such environmental contaminations, and bathing culture is rapidly changing and showers which have been used in a public bath are now mounted in a household bathroom while such people are increasing.

In general, users move a nozzle portion of the shower device disposed in a bathroom for taking a bath or shower toward a location of the body where the water needs to be showered while grasping the shower device by one hand, or after completing shower or bath over the whole body using the showing device put on a support disposed on a wall, users move from a location of the shower device to a location where a towel or drying device is put to clean moistures on head or body in order to remove moistures on their bodies.

However, users may be electrically shocked due to an insertion of a plug of the drying device into a wall outlet by wet hands for using the drying device, and it takes many times and is burdensome to dry hairs and body while grasping the drying device by the hand.

In addition, users must often find the towel for removing moistures after finishing the bath or shower, however, the towel may not be prepared in the bathroom, and the wet towel due to prior uses makes users feel uncomfortable even when the towel is prepared in the bathroom.

Meanwhile, the tap water supplied to the shower device contains impurities in hard water such as rust stains, colloids or heavy metals, which may cause skin diseases to easily occur on people having weak skins.

In addition, chloride remains in the tap water, which causes hairs or skin to be damaged or stimulated at the time of washing faces or hairs or taking a bath in a bathroom or a washroom, so that it is preferable to remove such remaining chloride.

To solve this problem, Japanese Patent Laid-Open Publication No. 2000-262428 discloses a shower system for purifying water.

This purifying shower system allows a plurality of water purifying cartridges to be received in a shelf disposed in a place where the shower system is installed to effectively use the space, wherein an original water input portion and a purified water output portion are disposed, the shelf receiving the purifying cartridges is disposed on a wall, a coupling hose is coupled to the purified water output portion formed on one side of the shelf, and a shower head is disposed at the end of the coupling hose.

However, such a purifying shower system purifies water only to remove impurities contained in the water.

Meanwhile, Korean Utility Registration No. 20-0357715 discloses a shower device having a function of blowing cool or warm winds, wherein a cool and warm wind blowing device having a warm wind pipe and a cool wind pipe is disposed on a wall of a bathroom or restroom while a coupling hose of the shower head allowing water to be sprayed for bath or shower is coupled to the warm wind pipe or the cool wind pipe of the cool and warm wind blowing device.

However, according to the shower device having the function of blowing cool or warm winds, the coupling hose must be coupled to the water faucet at the time of taking a bath or shower, and must be removed from the water faucet to be coupled to the cooling wind pipe or the warm wind pipe in order to remove moistures on the body or head after finishing the shower or bath, which are so burdensome.

Meanwhile, Japanese Patent Laid-Open Publication No. 2001-140305 discloses an air towel attaching water faucet, wherein a thermal wind output portion is disposed near a water output portion before hot water is mixed, and is coupled to a separate air towel (including an electrothermal heater and an air blower) to output the thermal wind, a UV sensor disposed at the thermal wind output portion operates to allow the thermal winds to blow for a predetermined time after hands are cleaned with water, however, this air towel attaching water faucet is applied to a washbowl only, which thus may be effectively used in a public restroom.

*However, this disclosed invention is only suitable for drying hands after hands are cleaned with water, but not suitable for drying head or body after taking a shower or bath, and has no function of purifying the water.

### DISCLOSURE OF INVENTION

### Technical Problem

The present invention is directed to a shower system where a drying device and a water purifying device are coupled to each other, which allows warm winds occurring from the drying device to blow through a showering device to rapidly remove moistures on head or body in front of the showering device without using a towel or moving to another place.

The present invention is also directed to a shower system which may remove rusty stains, colloids, heavy metals and so forth contained in faucet water to be applied to sensitive skins without side effects.

### Technical Solution

One aspect of the present invention provides a shower system having a drying device and a water purifying device, which allows warm winds occurring from the drying device to output through a shower head without moving to another place or removing moistures on a body by means of a towel after taking a bath or shower using a shower device in a bathroom, so that the moistures on the body and head may be dried for a short time, and impurities contained in the faucet water may be removed to make the water smooth, clean, and good for skin care.

### ADVANTAGEOUS EFFECTS

According to the present invention as described above, moistures remaining on the body after taking a shower may be dried by warm winds occurring from a dryer box for a short time without moving to another place.

In addition, the water purifying device of the present invention is a device which allows the faucet water to be filtered by a filter using germanium, yellow ocher, charcoal to transform hard water into soft water by means of ion exchange reaction, and removes impurities such as rusty stains, colloids and so forth contained in the faucet water by means of absorption to make the water smooth, clean, and good for especially skin care.

That is, metal and heavy metal materials remaining in the faucet water or underground water used for houses are removed by ion resins or the like to be transformed into soft water, so that wastes of skin pores are removed to make the skins soft after taking a bath or washing a face, thereby allowing cosmetics to be well permeated into the skin and preventing wrinkles from occurring to make the skins healthy and resilient.

In addition, skin diseases are prevented and hairs are protected, which is possible by removing wastes on the skin surface to prevent the skin from being aged, and prevents skins from various skin disorders, pimples, athlete's foots, moist tetters usually occurring on housewife, bacteria, atopic dermatitis, weak skins of babies, dry skins, loss of hairs of the old, and dandruffs.

### BRIEF DESCRIPTION OF THE DRAWINGS

Other objects and advantages of the present invention will be more clearly understood from the following description with reference to accompanying drawings, in which

FIG. 1 illustrates a perspective view of a shower system having a water purifying and drying function according to a first embodiment of the present invention;

FIG. 2 illustrates a cross-sectional view of a casing of the shower system having the water purifying and drying functions according to the first embodiment of the present invention;

FIG. 3 illustrates a side of the casing of the shower system having the water purifying and drying functions according to the first embodiment of the present invention;

FIG. 4 illustrates an enlarged view of a second shower head of the shower system having the water purifying and drying functions according to the first embodiment of the present invention;

FIG. 5 illustrates an enlarged drying device disposed in the casing of the shower system having the water purifying and drying functions according to the first embodiment of the present invention;

FIG. 6 illustrates a front view of a key input portion used in the present invention; and

FIG. 7 illustrates a perspective view of the shower system having the water purifying and drying functions according to a second embodiment of the present invention.

### BEST MODE FOR CARRYING OUT THE INVENTION

According to embodiments of the present invention, a shower system including a water faucet for selectively mixing cool water and warm water input from cool and war water inlet pipes disposed on a wall and selectively supplying the selectively mixed water to a first shower head or a second shower head through a water outlet pipe is provided, the shower system comprises: a drying device disposed near a coupling pipe extended to the second shower head and generating warm winds in a predetermined direction by an operation of a warm wind blower and an electrothermal heater.

In the present invention, the drying device preferably comprises: a casing formed to surround the coupling pipe; an electrothermal heater mounted within the casing; a wind blower for blowing the warm winds of the electrothermal heater through a warm wind pipe; a first wind blowing pipe for blowing the warm winds blown by the wind blower toward the second shower head; a second wind blowing pipe for blowing the warm winds blown by the wind blower toward the side of the casing; a microcomputer for adjusting the warm winds blown by the wind blower; and a key input portion disposed outside the casing for controlling states of the microcomputer.

The second wind blowing pipe preferably includes two wind blowing pipes for blowing the warm winds blown by the wind blower toward the right or left direction or both directions of the casing at the same time, and ends of the two wind blowing pipes have opening portions for supplying the warm winds outward toward the right and left doors of the casing, respectively.

The casing preferably further comprises a water purifying device for filtering and removing impurities of waters supplied from the water faucet.

The water purifying device preferably comprises: a first filter for filtering waters supplied through the water outlet pipe where germanium balls are filled in a predetermined container; a second filter for filtering the waters filtered by the first filter where yellow ochers are filled in a predetermined container; and a third filter for filtering again the waters filtered by the second filter where charcoals are filled in a predetermined container, wherein the waters sequentially purified by the filters are discharged through the second shower head.

Meanwhile, the a shower system may further comprise: a drying device disposed near a coupling pipe extended to the second shower head and generating warm winds in a predetermined direction by an operation of a warm wind blower and an electrothermal heater; and a water purifying device disposed within the casing for filtering and removing impurities of waters supplied from the water faucet.

According to other embodiments of the present invention, a shower system including a water faucet for selectively mixing cool water and warm water input from cool and war water inlet pipes disposed on a wall and selectively supplying the selectively mixed water to a first shower head or a second shower head through a water outlet pipe is provided, which comprise: a drying device disposed near the second shower head and within a casing for generating warm winds through the second shower head by means of operations of an electrothermal heater and a wind blower; and a microcomputer spaced apart from the second shower head for adjusting warm winds generated from the drying device and a key input portion remotely disposed from the drying device for providing an input signal of controlling states of the microcomputer.

### MODE FOR THE INVENTION

Hereinafter, a shower system according to a preferred embodiment of the present invention will be described in detail with reference to accompanying drawings.

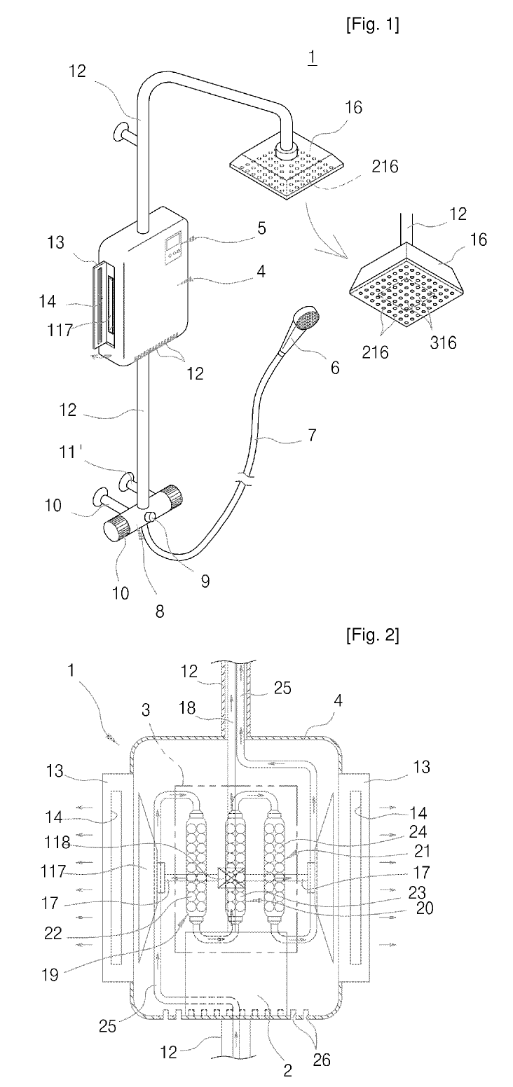

FIG. 1 illustrates a perspective view of a shower system having a water purifying and drying function according to a first embodiment of the present invention.

When the water faucet 8 is coupled to the cool and war water inflow pipes 11 and 11′ disposed on a wall in the shower apparatus 1 having the drying device and the water purifying device combined, a knob 10 for adjusting the warm waters which allows the cool and warm waters to be supplied to the water outlet pipe 25 is disposed at right and left sides of the water faucet.

In addition, a shower adjustment knob 9 is disposed in front of the water faucet 8, which is coupled to the shower head 6 by a highly flexible tube 7 disposed below the water faucet 8 to adjust supplying cool and war warm waters while taking a shower with the shower head 6 grasped by the hand.

In addition, the water outlet pipe 25 for supplying the cool and warm waters is vertically disposed above the water faucet 8, which is protected by a coupling pipe 12 inserted inside for protecting the water outlet pipe 25 and supporting the body casing 4.

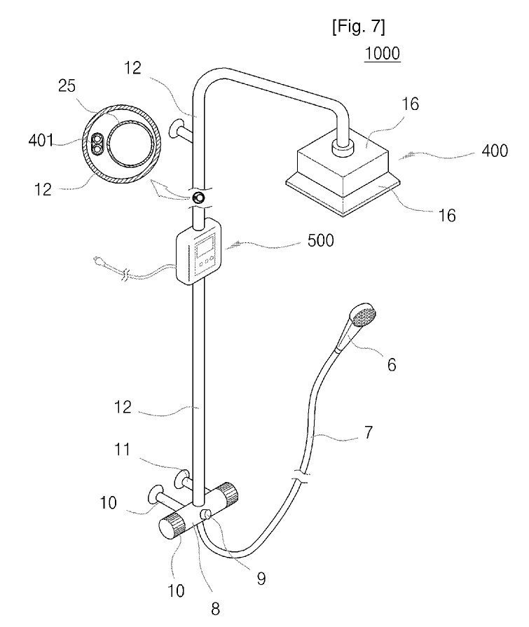

A water purifying device 3 and a drying device 2 are disposed within the body casing 4, doors to be opened or closed for allowing warm winds supplied from the drying device 2 to be output to the body are disposed at respective right and left sides of the casing, and a key input portion (see FIG. 7) for controlling operations of the drying device 2 is disposed at a front of the casing. In this case, the door 13 is designed to be opened by the warm winds occurring from the drying device 2 and closed at the time of turning off the drying device 2.

In addition, the water outlet pipe 25 and a warm wind pipe 18, which supply purified waters and warm winds from the water purifying device 3 and the drying device 2 to the head, are disposed above the casing 4, wherein the water outlet pipe 25 and a warm wind pipe 18 are drawn by the same length and inserted inside and ends having the same length are coupled to a second shower head 16 while the water outlet pipe 25 and a warm wind pipe 18 are bent to have an inclined angle.

Accordingly, the present invention provides a shower system 1 where the drying device 2 and the water purifying device 3 are coupled, which operates the drying device 2 by the manipulation of the key input portion 5 for drying the head and body by the warm winds without moving to another place or removing moistures on the head or body by means of towel after taking a shower with the purified water.

FIG. 2 illustrates a cross-sectional view of a casing 4 of the shower system having the water purifying and drying functions according to the present invention, wherein the shower system 1 of the present invention purifies the tap water by means of the water purifying device 3 disposed within the case 4 and outputs the warn winds by means of the drying device 2.

A coupling pipe 12 for supplying the water faucet 8 and the second shower head 16 is disposed above and below the casing 4.

The water outlet pipe 25 is disposed within the coupling pipe 12 positioned between the water faucet 8 and the body casing 4 and is coupled to the water purifying device 3, and the water outlet pipe 25 drawn from the water purifying device 3 and the warm wind pipe 18 for spraying the warm winds from the drying device 2 to the head are drawn together from the coupling pipe 12 positioned between the body casing 4 and the second shower head 16, which is then coupled to the second shower head 16.

The body casing 4 has doors 13 at its right and left sides, which are engaged with upper and lower hinges and are opened or closed by a rotating movement for allowing the warm winds occurring from the drying device 2 to be output.

The door 13 of the drying device, although not shown in the drawing, has a pushbutton structure in the body casing 4 which is opened or closed by a spring tension which is well known in the art.

In addition, an outlet 14 for outputting the warm warms in the longitudinal direction of the casing is disposed within the casing and the warm wind pipe 17 for blowing the warm winds occurring from the drying device to the body is engaged with a side of the casing when the door 13 of the drying device is closed or opened.

In addition, an air inlet 26 is disposed within and below the casing 4 for supplying an external air to the drying device 2.

Accordingly, the drying device 2 has the air input by means of a blower fan not shown in the drawing to allow the air to pass through a heating portion to the drying device and the second shower head 16, and at this time, the air is heated to warm winds to be supplied to the warm wind pipe 18 for spraying the warm winds to the head, and the drying device is divided into warm wind pipes 1 for spraying the warm winds to the body positioned at right and left sides of the warm wind pipe 18 so that the warm winds are supplied to the outlet 14 and output.

Meanwhile, a microcomputer not shown in the drawing adjusts the warm winds to be supplied, and a key input portion 5 disposed outside the casing 4 acts to provide an input signal for controlling the states of the microcomputer.

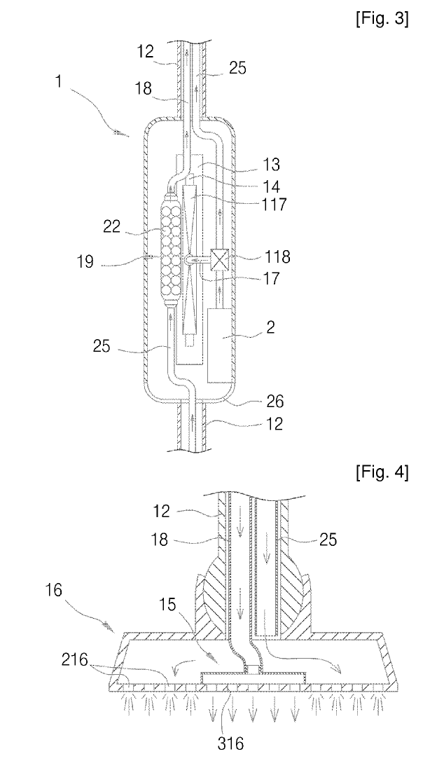

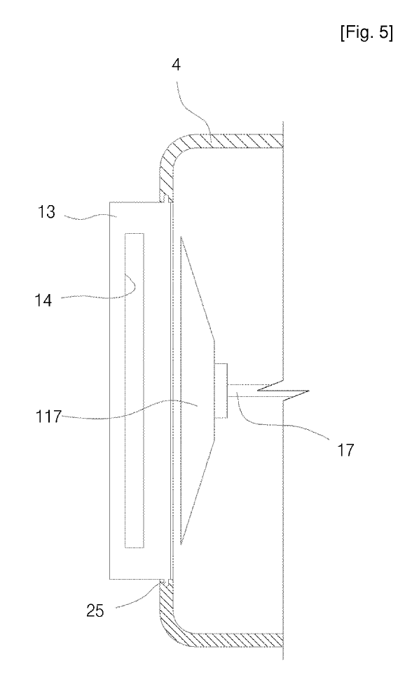

As shown in FIGS. 2 and 3, the warm wind pipe 17 for spraying the warm winds to the body includes two warm wind pipes for blowing the warm winds supplied by the warm wind blower in a left or right direction or both directions at the same time, and the warm wind pipes have opening portions 117 for supplying the warm winds toward the right and left doors 13 at the ends of the two warm wind pipes, and to this end, it is preferable to dispose a valve 118 controlled by the microcomputer at an intersection between the warm wind pipes 17 and 18.

In addition, impurities contained in the tap water such as rusty stains, colloids or the like supplied through the water outlet pipe 25 from the faucet 8 are absorbed and removed by the water purifying device 3, far infrared radiations and negative ions are discharged therefrom to make the water smooth, clean and good for skin care.

That is, the water purifying device 3 includes a first filter 19 where germanium balls 22 are filled in a certain container, a second filter 20 where yellow ochers 23 are filled in a certain container, and a third filter 21 where charcoals are filled in a certain container, wherein cool or warm waters supplied through the water outlet pipe 25 are filtered by the first filter 19, filtered by the second filter 20 coupled to the first filter 19 by the water outlet pipe 25, and then filtered by the third filter 21 above the second filter 20 so that the waters are sprayed from a water outlet 216 of the second shower head 16 coupled to the third filter 31 by the water outlet pipe 25.

Meanwhile, the germanium 22 acts to supply oxygen, discharge negative ions, strengthen immunity abilities, transform acid into alkali, remove poisons, and discharge heavy metals, the yellow ocher 23 acts to absorb harmful smells, strengthen monovalence, and discharge far infrared radiations, and the charcoal 24 acts to discharge negative ions, carry out deodorization, purification, filtering, and discharge far infrared radiations.

Accordingly, the drying device 2 is positioned in front of and within the body casing 4, and the water purifying device 3 is positioned behind the drying device 2.

FIG. 4 illustrates an enlarged view of a second shower head 16 of the shower system having the water purifying device and the drying device of the present invention, wherein waters purified and supplied from the water purifying device 3 and the drying device 2 are supplied to the water outlet pipe 25, and the warm winds are supplied to the second shower head 16 through the warm wind pipe 18 for spraying the warm winds to the head, the coupling pipe 12 is engaged with the body casing 4 such that it is engaged with the shower head 16 while it is inserted for protecting the water outlet pipe 25 and the warm wind pipe 18, and the warm winds supplied through the warm wind pipe 18 are sprayed through the air holes 316.

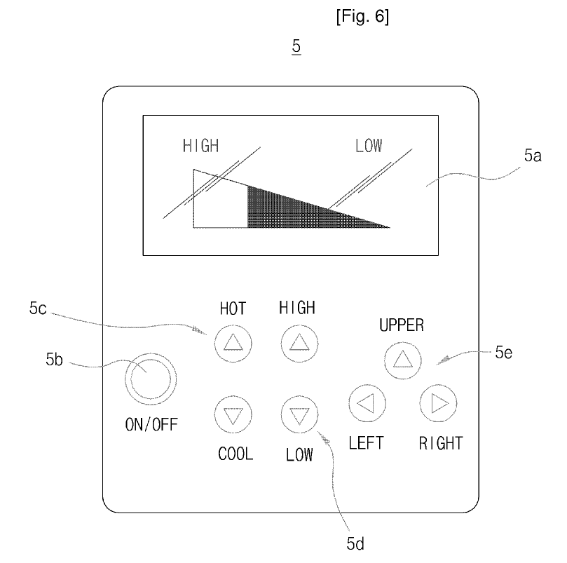

Referring to FIG. 6, the body casing 4 of the present invention has the key input portion 5, which is configured to identify operation states of the water purifying device 3 and the drying device 2 at the first time.

That is, the key input portion 5 includes a display 5a for visually displaying the operation states, wherein the key input portion has a power on/off switch 5b, buttons 5c for setting the temperature of cool or warm winds, buttons 5d for adjusting the intensity of the winds, and buttons 5e for controlling the warm winds to be output toward the second shower head 16 or right or left direction of the body casing 4.

Accordingly, the drying device 2 operates when the power switch 5b is turned on at the time of finishing the shower or bath, and at this time, the heater operates, the temperature of the warm winds may be adjusted by controlling the buttons 5c, the intensity of the winds may be adjusted by controlling the buttons 5d, or the warm winds are made to be sprayed toward the second shower head 16 or right or left direction of the body casing 4 by controlling the buttons 5e.

FIG. 7 illustrates a perspective view of the shower system according to a second embodiment of the present invention, wherein the same reference numerals as FIG. 1 indicate the same components, so that the detailed description thereof will be omitted except the difference therebetween.

As shown in FIG. 7, according to the second embodiment of the present invention, it can be seen that the drying device 2 together with the second shower head 16 is disposed in a separate case 400 and a microcomputer for adjusting the warm winds occurring from the drying device and a key input portion 500 for providing input signals controlling states of the microcomputer are separately disposed.

That is, the shower system 1000 of the present invention has the coupling pipe 12 disposed straight above the water faucet 8 and of which the upper portion is vertically bent to one side, and the shower head 16 and the drying device 2 integrated at the end of the coupling pipe 12, so that the drying function for drying the body and the shower function are included.

As such, the control line 401 for adjusting the drying device 2 is received with the water outlet pipe 25 within the coupling pipe 12 as shown in the enlarged view.

### INDUSTRIAL APPLICABILITY

Accordingly, the present invention allows the body and head to be dried for a short time using the drying device in one place after taking a shower so that it is very suitable for modern people.

1. A shower system including a water faucet for selectively mixing cool water and warm water input from cool and war water inlet pipes disposed on a wall and selectively supplying the selectively mixed water to a first shower head or a second shower head through a water outlet pipe, comprising:
a drying device disposed near a coupling pipe extended to the second shower head and generating warm winds in a predetermined direction by an operation of a warm wind blower and an electrothermal heater.

2. The shower system according to claim 1, wherein the drying device comprises:
a casing formed to surround the coupling pipe;
an electrothermal heater mounted within the casing;
a wind blower for blowing the warm winds of the electrothermal heater through a warm wind pipe;
a first wind blowing pipe for blowing the warm winds blown by the wind blower toward the second shower head;
a second wind blowing pipe for blowing the warm winds blown by the wind blower toward the side of the casing;
a microcomputer for adjusting the warm winds blown by the wind blower; and
a key input portion disposed outside the casing for controlling states of the microcomputer.

3. The shower system according to claim 2, wherein the second wind blowing pipe includes two wind blowing pipes for blowing the warm winds blown by the wind blower toward the right or left direction or both directions of the casing at the same time.

4. The shower system according to claim 3, wherein ends of the two wind blowing pipes have opening portions for supplying the warm winds outward toward the right and left doors of the casing, respectively.

5. The shower system according to claim 1, wherein the casing further comprises:
a water purifying device for filtering and removing impurities of waters supplied from the water faucet.

6. The shower system according to claim 5, wherein the water purifying device comprises:
a first filter for filtering waters supplied through the water outlet pipe where germanium balls are filled in a predetermined container;
a second filter for filtering the waters filtered by the first filter where yellow ochers are filled in a predetermined container; and
a third filter for filtering again the waters filtered by the second filter where charcoals are filled in a predetermined container,
wherein the waters sequentially purified by the filters are discharged through the second shower head.

7. A shower system including a water faucet for selectively mixing cool water and warm water input from cool and war water inlet pipes disposed on a wall and selectively supplying the selectively mixed water to a first shower head or a second shower head through a water outlet pipe, comprising:
a drying device disposed near a coupling pipe extended to the second shower head and generating warm winds in a predetermined direction by an operation of a warm wind blower and an electrothermal heater; and
a water purifying device disposed within the casing for filtering and removing impurities of waters supplied from the water faucet.

8. The shower system according to claim 7, wherein the drying device comprises:
a casing formed to surround the coupling pipe;
an electrothermal heater mounted within the casing;
a wind blower for blowing the warm winds of the electrothermal heater through a warm wind pipe;
a first wind blowing pipe for blowing the warm winds blown by the wind blower toward the second shower head;
a second wind blowing pipe for blowing the warm winds blown by the wind blower toward the side of the casing;
*a microcomputer for adjusting the warm winds blown by the wind blower; and
a key input portion disposed outside the casing for controlling states of the microcomputer.

9. The shower system according to claim 8, wherein the second wind blowing pipe includes two wind blowing pipes for blowing the warm winds blown by the wind blower toward the right or left direction or both directions of the casing at the same time.

10. The shower system according to claim 9, wherein ends of the two wind blowing pipes have opening portions for supplying the warm winds outward toward the right and left doors of the casing, respectively.

11. The shower system according to claim 7, wherein the water purifying device comprises:
a first filter for filtering waters supplied through the water outlet pipe where germanium balls are filled in a predetermined container;
a second filter for filtering the waters filtered by the first filter where yellow ochers are filled in a predetermined container; and
a third filter for filtering again the waters filtered by the second filter where charcoals are filled in a predetermined container,
wherein the waters sequentially purified by the filters are discharged through the second shower head.

12. A shower system including a water faucet for selectively mixing cool water and warm water input from cool and war water inlet pipes disposed on a wall and selectively supplying the selectively mixed water to a first shower head or a second shower head through a water outlet pipe, comprising:
a drying device disposed near the second shower head and within a casing for generating warm winds through the second shower head by means of operations of an electrothermal heater and a wind blower; and
a microcomputer spaced apart from the second shower head for adjusting warm winds generated from the drying device and a key input portion remotely disposed from the drying device for providing an input signal of controlling states of the microcomputer.

13. The shower system according to claim 12, wherein the drying device comprises:
a casing formed to surround the coupling pipe;
an electrothermal heater mounted within the casing;
a wind blower for blowing the warm winds of the electrothermal heater through a warm wind pipe; and
a wind blowing pipe for blowing the warm winds blown by the wind blower toward the second shower head.
